(19) United States
(12) Patent Application Publication
(10) Pub. No.: US 2016/0376201 A1
(43) Pub. Date: Dec. 29, 2016

(54) FIBER MATERIAL FOR REINFORCEMENT, PRODUCTION METHOD THEREOF, AND FIBER-REINFORCED CERAMIC COMPOSITE MATERIAL

(71) Applicant: CoorsTek KK, Tokyo (JP)

(72) Inventor: Shinichiro AONUMA, Hadano-shi (JP)

(21) Appl. No.: 15/178,428

(22) Filed: Jun. 9, 2016

(30) Foreign Application Priority Data
Jun. 29, 2015 (JP) 2015-129633

(51) Int. Cl. C04B 35/80; C04B 35/65; B05D 1/18

(52) U.S. Cl. CPC C04B 35/806; B05D 1/18; C04B 35/65; C04B 2235/3826; C04B 2235/5244

(57) ABSTRACT

The present invention relates to a fiber material for reinforcement containing a fiber aggregate containing plural fibers of a ceramic, a metal or a mixture thereof, and a porous structural body, in which the porous structural body fills a space among the plural fibers of the fiber aggregate, and covers at least a part of a surface of the fiber aggregate, and in which the porous structural body is in a state of being impregnated with a carbon material.

### TECHNICAL FIELD

The present invention relates to a fiber material for reinforcement containing a ceramic or a metal material, production method thereof, and a fiber-reinforced ceramic composite material using the fiber material for reinforcement.

### BACKGROUND ART

A ceramic material generally has excellent characteristics of light weight, high stiffness and high heat resistance as compared with a metal material, and meanwhile, has a weak point that it is a brittle material. To overcome this weak point, for example, a fiber-reinforced ceramic composite material having reinforced mechanical strength, containing fibers of a ceramic and a matrix part of a ceramic is widely known.

For example, Patent Document 1 discloses a fiber-reinforced silicon carbide ceramic obtained by coating silicon carbide short fibers with an oxide, a nitride or the like of boron, aluminum or carbon, and dispersing these in a matrix of silicon carbide, molding into a given shape, and then compacting the molded body. Patent Document 1 suppresses a reaction between the short fibers and a matrix during sintering by filling and covering the silicon carbide short fibers with boron nitride or the like, thereby preventing deterioration and breakage of SiC fibers.

Patent Document 2 discloses a fiber material for reinforcement in which spaces among fibers of a reinforcing fiber aggregate are filled with a layered structure material such as a graphitic carbon material and the fiber surface is covered with the layered structure material. Patent Document 2 discloses that by filling spaces among fibers of the reinforcing fiber aggregate with the layered structure material and by covering the entire fiber surface with the layered structure material, the layered structure material itself has high slip function, and fracture energy of a composite material using the fiber material for reinforcement is improved.

### PRIOR ART DOCUMENTS

### Patent Documents

Patent Document 1: JP-A-63-277563

Patent Document 2: JP-A-2011-157251

### SUMMARY OF THE INVENTION

### Problems that the Invention is to Solve

However, for example, in the case of using a fiber-reinforced ceramic composite material in an oxygen/water vapor atmosphere of 1,400° C. or higher, the technique disclosed in Patent Document 1 had a problem that when an environment-resistant coating formed on the surface thereof is damaged, for example, the boron nitride changes into boron oxide and vitrifies. The technique disclosed in Patent Document 2 also had a problem that when an environment-resistant coating on the surface of a product is damaged, the layered carbon material among fibers is consumed and thereby fracture energy is greatly decreased. Furthermore, it cannot be said that the technique which improves fracture energy by coating the surface of a single fiber to form a slip layer can be sufficiently achieved practically.

The present invention has been made in view of the above circumstances, and has an object to provide a fiber material for reinforcement in which fracture energy has been further improved as compared with a conventional material, and a fiber-reinforced ceramic composite material using the same.

### Means for Solving the Problems

The fiber material for reinforcement of the present invention is a fiber material for reinforcement containing a fiber aggregate containing plural fibers of a ceramic, a metal or a mixture thereof, and a porous structural body, in which the porous structural body fills a space among the plural fibers of the fiber aggregate, and covers at least a part of a surface of the fiber aggregate, and in which the porous structural body is in a state of being impregnated with a carbon material.

The fiber-reinforced ceramic composite material of the present invention contains the fiber material for reinforcement and a silicon carbide matrix.

The production method of a fiber material for reinforcement of the present invention includes a step of bringing a porous layer forming material containing a porous structural body into contact with a fiber aggregate containing plural fibers of a ceramic, a metal or a mixture thereof to fill a space among the plural fibers of the fiber aggregate with the porous structural body and cover at least a part of a surface of the fiber aggregate with the porous structural body, and a step of impregnating the porous structural body in a covered fiber aggregate obtained, with a carbon material.

### Advantageous Effects of the Invention

According to the present invention, by infiltrating a carbon material, followed by hardening, into a covered fiber aggregate that is obtained by filling a space among fibers of, and covering the surface of, a fiber aggregate with a porous structural body, the fiber material for reinforcement obtained has high fracture strength as compared with a conventional product.

Therefore, the fiber material for reinforcement of the present invention is preferably used in a fiber-reinforced ceramic composite material. Even in the case where cracks, peelings or the like are generated on an environment-resistant coating layer applied to the surface of a product containing the fiber-reinforced ceramic composite material, a carbon fiber contained in a porous layer on the surface of fibers is merely consumed and the porous layer is held. Therefore, high fracture energy can be maintained.

### BRIEF DESCRIPTION OF THE DRAWINGS

FIG. 1 is a view illustrating an outline of a fiber-reinforced ceramic composite material of the present invention.

FIG. 2A is I-I cross-sectional view of FIG. 1, and FIG. 2B is II-II cross-sectional view of FIG. 1.

FIG. 3 is a view illustrating a production process flow of a fiber material for reinforcement and a fiber-reinforced ceramic composite material using the fiber material for reinforcement of the present invention.

### MODE FOR CARRYING OUT THE INVENTION

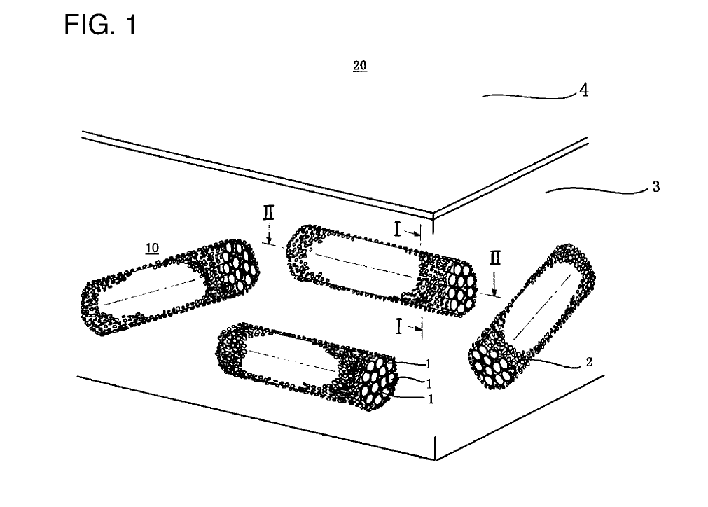

The embodiment of the present invention is described in detail below by reference to FIGS. 1 to 3.

### [Fiber Material for Reinforcement]

A fiber material for reinforcement 10 of the present invention is a fiber material for reinforcement 10 in which a space among fibers of a fiber aggregate 1 containing plural fibers of a ceramic, a metal or a mixture thereof is filled with a porous structural body 2, and the whole or a part of a surface of the fiber aggregate 1 is covered with the porous structural body 2, in which the porous structural body 2 is in a state of being impregnated with a carbon material.

That is, a raw material of the fiber material for reinforcement 10 is selected from optional ceramics or metal materials. Specifically, examples thereof include silicon carbide (SiC) ceramic and ceramics using carbon, boron, tungsten, and the like as raw materials. Of those, SiC ceramic is particularly preferred from the standpoints of heat resistance and oxidation resistance.

Carbon fibers and organic fibers that can form carbon fibers (for example, cellulose fibers, acryl fibers, pitch fibers and the like) are applicable as other raw materials. In the case of using organic fibers, after forming a fiber aggregate 1, a heat treatment is applied thereto to form ceramic fibers, and it can be used as the fiber material for reinforcement 10.

In the present invention, the fiber aggregate 1 is a fiber bundle and means the state that a plurality of fibers have been gathered and spaces have been formed thereamong by the fibers. The shape of the fiber aggregate 1 may be appropriately selected depending on a fiber-reinforced ceramic composite material 20 to be designed, and may be, for example, a sheet shape obtained by weaving long fibers, a felt shape, or a non-woven shape. A so-called short fiber bundle is preferred, in which several to several thousand fibers having a length of generally from 2 mm to 50 mm, and a diameter of generally from 1 μm to 30 μm and preferably from 5 μm to 20 μm, are bundled, and a needle-shape, rod-shape, small piece-shape, plate-shape, or bulk-shape is formed as the whole. Furthermore, a fiber bundle called a long fiber bundle, having a structure of having been continuously integrated in a longitudinal direction and presenting a state that the shape seen from a cross-section direction is similar as in the short fiber bundle is also preferred as the fiber aggregate 1 in the present invention.

When the diameter of fibers is less than 1 spaces among fibers become too narrow to be sufficiently filled with a porous structural body 2 in some cases. On the other hand, when the diameter of fibers exceeds 30 the spaces among fibers become relatively wide. As a result, in an area ratio between fibers and the porous structural body 2 per unit cross-sectional area, the proportion of the porous structural body 2 is increased, and defects are increased in the fiber aggregate 1 itself. As a result, toughness cannot be secured, and this may cause the decrease of mechanical characteristics of the fiber material for reinforcement 10.

In the present invention, SiC fiber aggregate 1 is particularly preferably used.

The spaces formed by fibers are filled with the porous structural body 2. That is, the porous structural body 2 forms a porous layer among fibers of, and on the surface of, the fiber aggregate 1. The fiber material for reinforcement 10 in which a porous layer has been formed among fibers of, and on the surface of, the fiber aggregate 1 is illustrated in FIG. 1.

The porous structural body 2 is not particularly limited so long as it is particles having a diameter that spaces formed by fibers can be filled with the particles, and examples thereof include yttrium (III) oxide (Y₂O₃), spinel (MgAl₂O₄), BN, and SiC. Of those, yttrium (III) oxide (Y₂O₃) and spinel (MgAl₂O₄) are preferred from the standpoint of oxidation resistance.

Many defects are formed inside the fiber aggregate 1 by filling inner spaces of the fiber aggregate 1 with the porous structural body 2, and as a result, the fiber aggregate 1 has high toughness. By combining the porous structure in the fiber aggregate 1 containing many defects with a layered carbon material having different tissue structure as a material compensating for brittleness of the porous structure, fracture energy can be further effectively improved as compared with a conventional technique that does not have those structures.

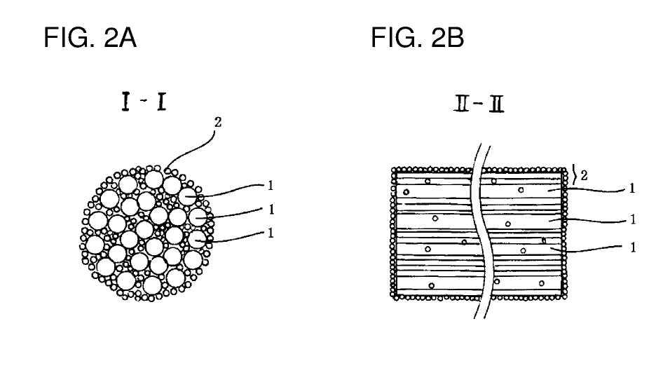

The fiber material for reinforcement 10 of the present invention has a structure in which not only spaces among fibers of the fiber aggregate 1, but its surface is covered with the porous structural body 2, as illustrated in FIG. 2A and FIG. 2B. The surface of the fiber material for reinforcement 10 indicates a surface in which the fiber aggregate 1 having spaces among fibers filled with the porous structural body 2 is considered as one bulk and the whole or a part of the surface of the fiber aggregate 1 is covered by the exposure of the porous structural body 2. At least 30% of the surface of the fiber aggregate 1 is covered with the porous structural body 2.

The thickness of the porous layer covering the fiber aggregate 1 is generally 0.1 μm or more and 200 μm or less, and preferably 2 μm or more and 20 μm or less. When the thickness of the porous layer is less than 0.1 μm, there is a case that impact resistance of the porous layer cannot be sufficiently maintained. On the other hand, when the thickness of the porous layer exceeds 200 μm, the volume of the porous layer itself becomes excessive, and due to the possibilities of peeling and breakage of the porous layer itself, it may affect the strength of the whole fiber-reinforced ceramic composite material 20 as a final product.

The thickness of the porous layer formed on the fiber surface is generally from 0.25 to 1.5 times the diameter of a single fiber constituting the fiber aggregate 1.

When the amount of the porous structural body 2 relative to the fiber aggregate 1 is small, a carbon material described hereinafter cannot be sufficiently infiltrated into the porous structural body 2. Accordingly, metallic silicon (Si) reacts with fibers, and fibers are fixed to each other or fibers are fixed to Si. As a result, fracture energy may be decreased. On the other hand, when the amount of the porous layer forming material used is large, fracture starting points are increased, and thereby the decrease of fracture energy and the decrease of strength may occur.

The fiber material for reinforcement 10 of the present invention has a structure that a carbon material (not shown) is infiltrated into the porous layer which fills spaces among fibers of, and covers the whole or a part of the surface of, the fiber aggregate 1. The carbon material is not only infiltrated into the porous layer, but is partially infiltrated into the fiber aggregate 1. The fracture energy of the fiber material for reinforcement 10 can be further improved by infiltrating the carbon material into the porous structural body 2 and fiber aggregate 1.

Examples of the carbon material include pitch, polyimide, vinyl chloride, and a mixed resin of phenol and polyvinyl butyral. Of those, pitch and polyimide are preferably used from the standpoint of residual carbon ratio. Furthermore, the carbon material is preferably an anisotropic material, and the shape thereof is basically a layered structure and finer structure may have any tissue structure of a network structure and mosaic structure.

It is necessary to change the amount of the carbon material depending on the shape (short fiber or long fiber) of the fiber aggregate.

When the amount of the carbon material relative to the fiber aggregate 1 and the porous structural body 2 is small, the carbon material cannot be sufficiently infiltrated into the inside of the porous structural body 2. As a result, almost no carbon tissue is formed, and thereby the fiber material for reinforcement 10 may be poor in impact resistance. On the other hand, when the amount of the carbon material is large, a large amount of carbon adheres to the surface of the fiber aggregate 1, and in the case of short fiber type fiber bundles, they may be a bulk form.

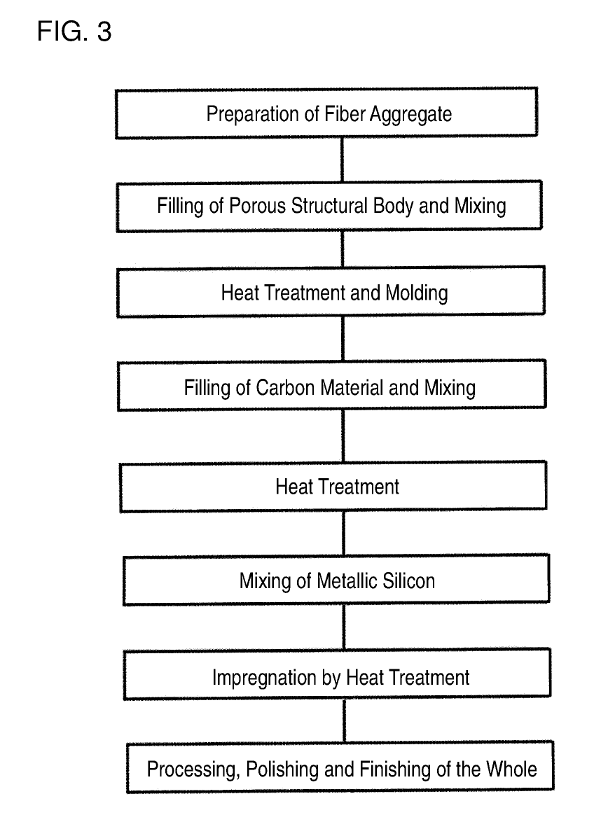

The production method of the fiber material for reinforcement 10 of the present invention includes a step of bringing a porous layer forming material into contact with the fiber aggregate 1 containing plural fibers of a ceramic, a metal or a mixture thereof to fill a space among the fibers of the fiber aggregate 1 with the porous layer forming material and cover the whole or a part of a surface of the fibers of the fiber aggregate 1 with the porous layer forming material, and a step of impregnating the porous structural body 2 in a covered fiber aggregate obtained, with a carbon material, as illustrated in a production process flow of FIG. 3.

As the method of filling and covering spaces among fibers and the whole or a part of the surface of the fiber aggregate 1 with the porous structural body 2, for example, dipping or electrophoresis is used. By using electrophoresis, the porous structural body 2 can be uniformly formed inside and on the surface of the fiber aggregate 1 simply and efficiently as compared with a method such as a CVD method or a sputtering method, in which each single fiber is film-formed and production cost is expensive. In the case of using electrophoresis, it can be carried out by preparing a slurry of a raw material that is desired to be formed on the fiber surface, continuously dipping long fiber bundles in the slurry, and applying voltage between the fiber bundles and the slurry or a metal slurry container. Long fibers on which a coating film has been formed by adding a binder component in the slurry are wound up after hot or air drying and curing. In some cases, it is necessary to make a slurry have polarity by using an acid or an alkali. In the case of long fiber, a sheet-like fiber is prepared by weaving it to form a prepreg. Alternatively, it is possible to be formed by direct application to or by electrophoresis of a sheet-like fiber. Furthermore, short fibers can be obtained by cutting the fibers wound up, and it becomes possible to obtain a product shape by a desired molding.

The porous layer forming material used in the formation of the porous structural body 2 contains the porous structural body 2 and a binder. The binder is not particularly limited so long as it can fix the porous structural body 2 to the fiber surface. As a solvent used for dispersion, an organic solvent such as ethanol, 2-butanol or acetone, other than water, can be used.

In preparing the porous layer forming material, the porous structural body 2 is mixed with the binder such that the concentration of the porous structural body 2 is 10 wt % or more and 70 wt % or less. When ceramic particles are used as the porous structural body 2, the porous layer forming material becomes a slurry state and therefore, the handling is easy to form the porous structure.

When the concentration of the porous structural body 2 in the porous layer forming material is less than 10 wt %, the porous layer cannot be sufficiently formed among fibers of, and on the surface of, the fiber aggregate 1 in some cases.

It is preferred in the short fiber system to mix the fiber aggregate 1 with the porous layer forming material in a range of from 1:0.5 to 1:9 in weight ratio. When the weight ratio between the fiber aggregate 1 and the porous layer forming material is within the above range, the fiber material for reinforcement 10 can sufficiently exhibit the effect of improving fracture energy.

The method and time for filling and covering spaces among fibers of and the surface of the fiber aggregate 1 with the porous structural body 2 can be optionally determined. A drying step, a heating step or both may be included in the formation process of the porous structural body 2 for the purpose of volatilization of an organic solvent (binder).

After impregnating the fiber aggregate 1 with the porous layer forming material, it may be immediately dried and may be allowed to stand for an appropriate time and then dried. A period for which the fiber aggregate is allowed to stand is up to the complete infiltration of the porous layer forming material into spaces within the fiber aggregate 1 and the complete vaporization of an organic solvent in the porous layer forming material, and is for example, 0.25 hours or more at room temperature. Up to the complete vaporization of an organic solvent does not require strict judgment and can be judged by a dry state of a porous layer forming material by visual observation of an operator.

The covering of the fiber aggregate 1 with the porous layer forming material may be conducted only one time, and, after once forming, an operation of again impregnating the fiber aggregate 1 with a slurry obtained by dispersing in the above-described organic solvent or the like may be conducted.

The drying is performed by conducting a heat treatment in the atmosphere or an inert atmosphere. In the heat treatment, the holding temperature is from 40 to 120° C. and preferably from 60 to 80° C., and the holding time is from 5 minutes to 0.5 hours and preferably from 0.3 to 0.6 hours. By conducting the heat treatment, an organic solvent volatilizes, and the porous structural body 2 can be fixed to and filled in the spaces among fibers.

In the production method of the fiber material for reinforcement 10 of the present invention, as illustrated in a production process flow of FIG. 3, after filling and covering spaces among fibers of and the surface of the fiber aggregate 1 with the porous structural body 2, the porous layer of the covered fiber aggregate is impregnated with a carbon material, thereby producing the fiber material for reinforcement. Specifically, the covered fiber aggregate is impregnated with the carbon material, and then maintained at a temperature of from 120 to 180° C. for from 0.5 to 1.0 hour. As a result, the carbon material infiltrated into the porous structural body 2 and a part of the fiber aggregate 1 is solidified and the fiber material for reinforcement 10 is formed.

### [Fiber-Reinforced Ceramic Composite Material]

The fiber-reinforced ceramic composite material 20 of the present invention contains the fiber material for reinforcement 10 obtained above and an SiC matrix 3. By combining the fiber material for reinforcement 10 with the SiC matrix 3 to form a composite material, mechanical strength of the composite material obtained is enhanced.

The amount of the SiC matrix 3 used is generally from 30 to 120 g and preferably from 50 to 80 g, per 100 g of the fiber material for reinforcement.

The short fiber type fiber-reinforced ceramic composite material 20 has a form that many bundles of fiber materials for reinforcement 10 are arranged in the SiC matrix 3 in the state of slightly inclining horizontally or vertically, and are overlapped, as illustrated in FIG. 1. By having the form, a strong composite material having improved mechanical strength can be obtained. FIG. 1 illustrates that the fiber materials for reinforcement 10 are randomly contained in the fiber-reinforced ceramic composite material 20. However, in the fiber material for reinforcement 10 in FIG. 1, the porous structural body adhered to the surface of both ends thereof and the carbon material are not shown.

A conventional technique can be applied to the method for producing the fiber-reinforced ceramic composite material 20 from the fiber material for reinforcement 10. For example, after mixing metallic Si with the fiber material for reinforcement 10, the resultant is heated at from 1,400 to 1,800° C. for from 5 to 120 minutes to infiltrate the metallic Si into the fiber material for reinforcement 10, thereby forming a compact body. As a result, a tissue containing isotropic SiC as a main component can be formed inside and on the surface of the fiber material for reinforcement 10.

The content rate of the SiC matrix 3 in the fiber-reinforced ceramic composite material 20 is from 20 to 80 wt %. Where the content rate of silicon carbide matrix is more than 80 wt %, cracks may be generated in the fiber-reinforced ceramic composite material 20. On the other hand, where the content rate is less than 20 wt %, excellent characteristics of the SiC matrix 3, such as heat resistance, oxidation resistance and strength, may not sufficiently be imparted to the fiber-reinforced ceramic composite material 20.

The content rate of the fiber aggregate 1 in the fiber-reinforced ceramic composite material 20 is generally from 25 to 75 wt % and preferably from 30 to 60 wt %.

The fiber-reinforced ceramic composite material 20 thus obtained has durability even at high temperature of 1,400° C. or higher in an oxygen atmosphere. Therefore, by applying environment-resistant coating such as Y₂O₃, ZrO₂ or Al₂O₃ to the surface of the fiber-reinforced ceramic composite material 20 of the present invention, it is preferably used as the fiber-reinforced ceramic composite material 20 of a sliding wear resistant member; a bearing of a rotating body; a pedestal of a breaking system of a semiconductor production apparatus, a grinder or the like; and the like.

### EXAMPLES

The present invention is further specifically described below based on Examples, but the present invention is not construed as being limited to the following Examples.

### Example 1

SiC fiber bundles (TYRANNO SA, manufactured by Ube Industries, Ltd.) were dipped in an organic solvent-based slurry (solid content:alcohol:polyimide resin=5:100:10 by weight ratio) obtained by adding one kind or two or more kinds of organic solvents selected from ethanol, 2-butanol and acetone (hereinafter simply referred to as an “organic solvent”) and a polyimide resin to yttrium (III) oxide (Y₂O₃) powder (particle size distribution D50%: 0.5 to 2 μm) (high BET product, manufactured by Nippon Yttrium Co., Ltd), followed by drying, and the oxide (Y₂O₃) powder was fixed to the inside and the surface of the SiC fiber bundles.

A satin-woven sheet was prepared by using the covered fiber bundles obtained. Next, the sheet of the covered fiber bundles was dipped in an organic solvent-based slurry (solid content:alcohobbinder=30:100:20 by weight ratio) obtained by adding an organic solvent and a binder (phenol resin) to SiC powder (particle size distribution D50%: 2.3 μm) (GMF-S, manufactured by Pacific Rundum Co., Ltd.), followed by drying, to prepare a prepreg. The prepregs were laminated and set in a mold heated to 120° C., and a hardened body (120 mm×120 mm×5 mm thick) was prepared by uniaxial pressing.

Next, the hardened body obtained was heat-treated at 600° C. in an inert atmosphere, and a binder component was scattered to obtain a burned body. The burned body obtained was impregnated with a polyimide resin (manufactured by Ube Industries, Ltd.) up to the inside of the SiC fiber bundles. After the impregnation, a heat treatment was performed at 300° C. or lower for 60 minutes to cure the polyimide resin.

Metallic Si powder (4N, manufactured by Koj undo Chemical Laboratory Co.,

Ltd.) was placed on the burned body obtained and an impregnation was performed by the heat treatment at 1,500° C. or higher to form a compact body. Thus, an SiC fiber-reinforced SiC ceramic composite material was obtained.

The composite material obtained was processed into a rod shape of 3 mm×4 mm×40 mm, and fracture energy according to the standard of The Ceramic Society of

Japan (JCRS 201-1994) and apparent strength at that time were measured and evaluated. In the case where the fracture energy of the rod-shaped sample was measured to be 500×10⁻⁴ J/m², the sample was evaluated as “Good”. The same evaluation criterion was used in the following Examples and Comparative Examples.

The results are shown in Table 1. From the observation of a fracture surface after the measurement, the thickness of Y₂O₃ formed on the outer surface of the fiber bundles was about 10 μm. Furthermore, the inside of the fiber bundles was also filled with Y₂O₃.

The processed sample was further exposed to an air atmosphere at high temperature of 1,350° C. for 1 hour. After the exposure, the temperature was decreased to room temperature, and fracture energy and apparent strength at that time were similarly measured.

### Example 2

SiC fiber bundles (TYRANNO SA, manufactured by Ube Industries, Ltd.) were dipped in an organic solvent-based slurry (solid content:alcohol:polyimide resin=5:100:10 by weight ratio) obtained by adding an organic solvent and a polyimide resin to Y₂O₃ powder (particle size distribution D50%: 0.5 to 2 μm) (high BET product, manufactured by Nippon Yttrium Co., Ltd), followed by drying, and the oxide (Y₂O₃) powder was fixed to the inside and surface of the SiC fiber bundles.

A satin-woven sheet was prepared using the covered fiber bundles obtained. Next, the sheet of the covered fiber bundles was dipped in an organic solvent-based slurry (solid content:alcohol:binder=10:100:20 by weight ratio) obtained by adding an organic solvent and a binder (phenol resin) to SiC powder (particle size distribution D50%: 2.3 μm) (GMF-S, manufactured by Pacific Rundum Co., Ltd.), followed by drying, to prepare a prepreg. The prepregs were laminated and set in a mold heated to 120° C., and a hardened body (120 mm×120 mm×5 mm thick) was prepared by uniaxial pressing.

Next, the hardened body obtained was heat-treated at 600° C. in an inert atmosphere, and a binder component was scattered to obtain a burned body. The burned body obtained was impregnated with a pitch (manufactured by JFE Chemical Corporation) up to the inside of the fiber bundles. After the impregnation, a heat treatment was performed in an oxygen atmosphere to infusibilize and immobilize the resin.

Metallic Si powder (4N, manufactured by Kojundo Chemical Laboratory Co., Ltd.) was placed on the hardened body obtained and an impregnation was performed by the heat treatment at 1,500° C. or higher to form a compact body. Thus, an SiC fiber-reinforced SiC ceramic composite material was obtained.

The composite material obtained was processed into a rod shape of 3 mm×4 mm×40 mm, and fracture energy according to the standard of The Ceramic Society of Japan (JCRS 201-1994) and apparent strength at that time were measured and evaluated.

The results are shown in Table 1. From the observation of a fracture surface after the measurement, the thickness of Y₂O₃ formed on the outer surface of the fiber bundles was about 10 μm. Furthermore, the inside of the fiber bundles was also filled with Y₂O₃.

### Example 3

SiC fiber bundles (TYRANNO SA, manufactured by Ube Industries, Ltd.) were dipped in an organic solvent-based slurry (solid content:alcohol:polyimide resin=5:100:10 by weight ratio) obtained by adding an organic solvent and a polyimide resin to Y₂O₃ powder (particle size distribution D50%: 0.5 to 2 μm) (high BET product, manufactured by Nippon Yttrium Co., Ltd), followed by drying, and the oxide (Y₂O₃) powder was fixed to the inside and surface of the SiC fiber bundles.

The fiber bundles were cut to form short fibers. Next, the cut SiC fiber bundles were kneaded with an organic solvent-based slurry (solid content:alcohobbinder=30:100:20 by weight ratio) obtained by adding an organic solvent and a binder (phenol resin) to SiC powder (particle size distribution D50%: 2.3 μm) (GMF-S, manufactured by Pacific Rundum Co., Ltd.), followed by drying, to obtain a granular granulated body. The granulated body was charged in a mold heated to 120° C., and a hardened body (120 mm×120 mm×6 mm thick) was prepared by uniaxial pressing.

Next, the hardened body obtained was heat-treated at 600° C. in an inert atmosphere, and a binder component was scattered to obtain a burned body. The burned body obtained was impregnated with a polyimide resin (manufactured by Ube Industries, Ltd.) up to the inside of the fiber bundles. After the impregnation, a heat treatment was performed at 300° C. or lower to cure the polyimide resin.

Metallic Si powder (4N, manufactured by Koj undo Chemical Laboratory Co., Ltd.) was placed on the hardened body obtained and an impregnation was performed by the heat treatment at 1,500° C. or higher to form a compact body. Thus, an SiC fiber-reinforced SiC ceramic composite material was obtained.

The composite material obtained was processed into a rod shape of 3 mm×4 mm×40 mm, and fracture energy according to the standard of The Ceramic Society of

Japan (JCRS 201-1994) and apparent strength at that time were measured and evaluated.

The results are shown in Table 1. From the observation of a fracture surface after the measurement, the thickness of Y₂O₃ formed on the outer surface of the fiber bundles was about 10 μm. Furthermore, the inside of the fiber bundles was also filled with Y₂O₃.

### Example 4

SiC fiber bundles were dipped in an organic solvent-based slurry (solid content: alcohol:polyimide resin=3:100:10 by weight ratio) obtained by adding an organic solvent and a polyimide resin to spinel (MgAl₂O₄) powder (particle size distribution D50%: 1 μm) (manufactured by Baikowski Japan), followed by drying, and the oxide (MgAl₂O₄) powder was fixed to the inside and surface of the SiC fiber bundles.

The fiber bundles were cut to form short fibers. Next, the cut SiC fiber bundles were kneaded with an organic solvent-based slurry (solid content:alcohol:binder=30:100:20 by weight ratio) obtained by adding an organic solvent and a binder (phenol resin) to SiC powder (particle size distribution D50%: 2.3 μm) (GMF-S, manufactured by Pacific Rundum Co., Ltd.), followed by drying, to obtain a granular granulated body. The granulated body was charged in a mold heated to 120° C., and a hardened body (120 mm×120 mm×6 mm thick) was prepared by uniaxial pressing.

Next, the hardened body obtained was heat-treated at 600° C. in an inert atmosphere, and a binder component was scattered to obtain a burned body. The burned body obtained was impregnated with a polyimide resin up to the inside of the fiber bundles. After the impregnation, a heat treatment was performed at 300° C. or lower to cure the polyimide resin.

Metallic Si powder (4N, manufactured by Koj undo Chemical Laboratory Co., Ltd.) was placed on the hardened body obtained and an impregnation was performed by the heat treatment at 1,500° C. or higher to form a compact body. Thus, an SiC fiber-reinforced SiC ceramic composite material was obtained.

The composite material obtained was processed into a rod shape of 3 mm×4 mm×40 mm, and fracture energy according to the standard of The Ceramic Society of Japan (JCRS 201-1994) and apparent strength at that time were measured and evaluated.

The results are shown in Table 1. From the observation of a fracture surface after the measurement, the thickness of the spinel formed on the outer surface of the fiber bundles was about 5 μm. Furthermore, the inside of the fiber bundles was also filled with the spinel.

### Example 5

Plain-woven sheet-like SiC fiber was dipped in an organic solvent-based slurry (solid content: alcohol:polyimide resin=12:100:10 by weight ratio) obtained by adding an organic solvent and a binder (polyimide resin) to BN powder (FS-1, average particle diameter: 1 μm or less) (manufactured by Mizushima Ferroalloy Co., Ltd.), followed by drying, and the BN powder was fixed to the inside and the surface of the SiC fiber bundles.

Next, the BN-fixed sheet-like SiC fiber was dipped in an organic solvent-based slurry (solid content:alcohobbinder=30:100:20 by weight ratio) obtained by adding an organic solvent and a binder (phenol resin) to SiC powder (particle size distribution D50%: 2.3 μm) (GMF-S, manufactured by Pacific Rundum Co., Ltd.), followed by fixing. A plurality of the sheets were prepared and laminated. The resulting laminate was placed in a mold heated to 120° C., and a hardened body (120 mm×120 mm×5 mm thick) was prepared by uniaxial pressing.

Next, the hardened body obtained was heat-treated at 600° C. in an inert atmosphere, and a binder component was scattered to obtain a burned body. The burned body obtained was impregnated with a polyimide resin up to the inside of the fiber bundles. After the impregnation, a heat treatment was performed at 300° C. or lower to cure the polyimide resin.

Metallic Si powder (4N, manufactured by Kojundo Chemical Laboratory Co., Ltd.) was placed on the burned body obtained and an impregnation was performed by the heat treatment at 1,500° C. or higher to form a compact body. Thus, an SiC fiber-reinforced SiC ceramic composite material was obtained.

The composite material obtained was processed into a rod shape of 3 mm×4 mm×40 mm, and fracture energy according to the standard of The Ceramic Society of Japan (JCRS 201-1994) and apparent strength at that time were measured and evaluated.

The results are shown in Table 1. From the observation of a fracture surface after the measurement, the thickness of BN formed on the outer surface of the fiber bundles was about 20 μm. At this time, BN remained also in the fiber bundles, and its depth was about 30 μm. Other part was filled with carbon.

### Example 6

Plain-woven sheet-like SiC fiber was dipped in an organic solvent-based slurry (solid content:alcohobbinder=30:100:20 by weight ratio) obtained by adding an organic solvent and a binder (polyimide resin) to BN powder (FS-1, average particle diameter: 1 μm or less) (manufactured by Mizushima Ferroalloy Co., Ltd.), followed by drying, and the BN powder was fixed to the inside and the surface of the SiC fiber bundles.

The sheet obtained was impregnated with the polyimide resin up to the inside of the fiber bundles. After the impregnation, a heat treatment was performed at 150° C. or lower to semi-cure the polyimide resin.

Next, the BN-fixed sheet-like SiC fiber was dipped in an organic solvent-based slurry (solid content: alcohol:binder=30:100:20 by weight ratio) obtained by adding an organic solvent and a binder (phenol resin) to SiC powder (particle size distribution D50%: 2.3 μm) (GMF-S, manufactured by Pacific Rundum Co., Ltd.), followed by fixing. A plurality of the sheets were prepared and laminated. The resulting laminate was placed in a mold heated to 120° C., and a hardened body (120 mm×120 mm×5 mm thick) was prepared by uniaxial pressing.

Next, the hardened body obtained was heat-treated at 600° C. in an inert atmosphere, and a binder component was scattered to obtain a burned body.

Metallic Si powder (4N, manufactured by Koj undo Chemical Laboratory Co., Ltd.) was placed on the burned body obtained and an impregnation was performed by the heat treatment at 1,500° C. or higher to form a compact body. Thus, an SiC fiber-reinforced SiC ceramic composite material was obtained.

The composite material obtained was processed into a rod shape of 3 mm×4 mm×40 mm, and fracture energy according to the standard of The Ceramic Society of Japan (JCRS 201-1994) and apparent strength at that time were measured and evaluated.

The results are shown in Table 1. From the observation of a fracture surface after the measurement, the thickness of BN formed on the outer surface of the fiber bundles was about 5 μm. At this time, the inside of the fiber bundles was filled with carbon.

### Comparative Example 1

SiC fiber bundles were dipped in an organic solvent-based slurry (solid content:alcohol:binder=1.5:100:20 by weight ratio) obtained by adding an organic solvent and a polyimide resin to Y₂O₃ powder (particle size distribution D50%: 0.5 to 2 μm) (high BET product, manufactured by Nippon Yttrium Co., Ltd), followed by drying, and the oxide (Y₂O₃) powder was fixed to the inside and the surface of the SiC fiber bundles.

A satin-woven sheet was prepared by using the above fiber bundles. Next, the satin-woven sheet was dipped in an organic solvent-based slurry (solid content:alcohol:binder=30:100:20 by weight ratio) obtained by adding an organic solvent and a binder (phenol resin) to SiC powder (particle size distribution D50%: 2.3 μm) (GMF-S, manufactured by Pacific Rundum Co., Ltd.), followed by drying, to prepare a prepreg. The prepregs were laminated and set in a mold heated to 120° C., and a hardened body was prepared by uniaxial pressing.

Next, the hardened body obtained was heat-treated at 600° C. in an inert atmosphere, and a binder component was scattered to obtain a burned body. Metallic Si powder was placed on the burned body obtained and an impregnation was performed by the heat treatment at 1,500° C. or higher to form a compact body. Thus, an SiC fiber-reinforced SiC ceramic composite material was obtained.

The composite material obtained was processed into a rod shape of 3 mm×4 mm×40 mm, and fracture energy according to the standard of The Ceramic Society of Japan (JCRS 201-1994) and apparent strength at that time were measured and evaluated.

The results are shown in Table 1. Fracture surface after the measurement was observed by SEM.

### Comparative Example 2

SiC fiber bundles (TYRANNO SA, manufactured by Ube Industries, Ltd.) were dipped in an organic solvent-based slurry (solid content:alcohol:binder=1.5:100:20 by weight ratio) obtained by adding an organic solvent and a binder (polyimide resin) to MgAl₂O₄ powder (particle size distribution D50%: 1 μm) (manufactured by Baikowski Japan), followed by drying, and the oxide (MgAl₂O₄) powder was fixed to the inside and the surface of the SiC fiber bundles.

The fiber bundles were cut to form short fibers. Next, the cut SiC fiber bundles were kneaded with an organic solvent-based slurry (solid content:alcohol:binder=30:100:20 by weight ratio) obtained by adding an organic solvent and a binder (phenol resin) to SiC powder (particle size distribution D50%: 2.3 μm) (GMF-S, manufactured by Pacific Rundum Co., Ltd.), followed by drying, to obtain a granular granulated body. The granulated body was charged in a mold heated to 120° C., and a hardened body (120 mm×120 mm×6 mm thick) was prepared by uniaxial pressing.

Next, the hardened body obtained was heat-treated at 600° C. in an inert atmosphere, and a binder component was scattered to obtain a burned body. Metallic Si powder was placed on the burned body obtained and an impregnation was performed by the heat treatment at 1,500° C. or higher to form a compact body. Thus, an SiC fiber-reinforced SiC ceramic composite material was obtained.

The composite material obtained was processed into a rod shape of 3 mm×4 mm×40 mm, and fracture energy according to the standard of The Ceramic Society of Japan (JCRS 201-1994) and apparent strength at that time were measured and evaluated.

The results are shown in Table 1. Fracture surface after the measurement was observed by SEM.

TABLE 1

| | Fracture Energy | Apparent Strength | |
|---|---|---|---|
| | (×10⁻⁴ J/m²) | (MPa) | Evaluation |
| Example 1 | 1100 | 200 | Good |
| Example 1 | 940 | 150 | Good |
| | | | (High Temperature |
| | | | Exposure) |
| Example 2 | 1000 | 230 | Good |
| Example 3 | 1020 | 180 | Good |
| Example 4 | 1110 | 210 | Good |
| Example 5 | 1210 | 170 | Good |
| Example 6 | 1050 | 150 | Good |
| Comparative | 50 | 300 | Poor |
| Example 1 | | | |
| Comparative | 30 | 280 | Poor |
| Example 2 | | | |

From Table 1, since a layered carbon is formed in the porous layer in Examples 1 to 6 as compared with Comparative Examples 1 and 2, fixation between molten metallic Si and SiC fibers can be suppressed. As a result, it is understood that the SiC fiber-reinforced SiC ceramic composite material can obtain large fracture energy, and brittleness inherent in ceramics can be overcome. In the observation of a fracture surface in Comparative Examples 1 and 2, carbon layer was not observed and therefore, Si was infiltrated into the porous layer and Si was fixed to the surface of SiC fibers. As a result, it is understood that cracks proceeded linearly and a fracture energy value as an index of cracking resistance was low.

Furthermore, in Example 1, sufficient fracture energy and strength were maintained without great decrease in the characteristics after high temperature exposure. Though the internal carbon layer was oxidized and scattered by high temperature exposure, development of cracks was absorbed by the porous layer and did not proceed linearly. Therefore, sufficient characteristics could be obtained.

The present application is based on Japanese Patent Application No. 2015-129633 filed on Jun. 29, 2015, and the contents thereof are incorporated herein by reference.

### INDUSTRIAL APPLICABILITY

The fiber material for reinforcement and fiber-reinforced ceramic composite material of the present invention are preferably used in various parts represented by movable system which is lightweight and used at high temperature. Furthermore, SiC as a main component has high corrosion resistance, and therefore, those materials are preferred as a heat-resistant member used in various heat treatments.

### DESCRIPTION OF REFERENCE NUMERALS AND SIGNS

1: Fiber aggregate

2: Porous structural body

3: SiC matrix

4: Environment-resistant coating

10: Fiber material for reinforcement

20: Fiber-reinforced ceramic composite material

1. A fiber material for reinforcement comprising:
a fiber aggregate comprising plural fibers of a ceramic, a metal or a mixture thereof; and
a porous structural body,
wherein the porous structural body fills a space among the plural fibers of the fiber aggregate, and covers at least a part of a surface of the fiber aggregate, and
wherein the porous structural body is in a state of being impregnated with a carbon material.

2. A fiber-reinforced ceramic composite material, comprising the fiber material for reinforcement described in claim 1 and a silicon carbide matrix.

3. A production method of a fiber material for reinforcement, comprising:
a step of bringing a porous layer forming material comprising a porous structural body into contact with a fiber aggregate comprising plural fibers of a ceramic, a metal or a mixture thereof to fill a space among the plural fibers of the fiber aggregate with the porous structural body and cover at least a part of a surface of the fiber aggregate with the porous structural body; and
a step of impregnating the porous structural body in a covered fiber aggregate obtained, with a carbon material.
